(19) United States
(12) Patent Application Publication
(10) Pub. No.: US 2012/0176889 A1
(43) Pub. Date: Jul. 12, 2012

(54) NETWORK FAILOVER PROTECTION

(75) Inventors: Ian Cleary, Kirmington (GB); Daniel Sjoberg, London (GB)

(73) Assignee: LEVEL 3 COMMUNICATIONS, LLC, Broomfield, CO (US)

(21) Appl. No.: 13/270,477

(22) Filed: Oct. 11, 2011

Related U.S. Application Data
(60) Provisional application No. 61/392,447, filed on Oct. 12, 2010.

(51) Int. Cl. H04L 12/24; H04L 12/64

(52) U.S. Cl. 370/217

(57) ABSTRACT

Embodiments generally disclosed herein include a computer-implemented method for providing network failover functionality. The method includes providing service over a transport network from a first customer location to a second customer location. The method further includes detecting a network failure in the transport network and, in response, provisioning service over an Internet Protocol (IP) transit network from the first customer location to the second customer location. In one example embodiment, the network failure can be caused by a link failure in the transport network. In another example embodiment, the network failure can be used by a node failure in the transport network (e.g., failure of a dense wavelength division multiplexing device).

### RELATED APPLICATIONS

The present non-provisional utility application claims priority under 35 U.S.C. § 119(e) to U.S. Provisional Patent Application No. 61/392,447 titled “Network Failover Protection,” filed on Oct. 12, 2010, which is hereby incorporated by reference herein.

### TECHNICAL FIELD

Embodiments presently disclosed generally relate to network communications. More specifically, embodiments herein relate to network failover protection for heterogeneous network types and services.

### BRIEF DESCRIPTION OF DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of a network environment for providing network failover and protection functionality.

FIG. 2 is a block diagram of a computer system suitable for performing network management and failure detection in accordance with an example embodiment.

FIG. 3 is a flow chart that shows processing operations performed by a network manager in accordance with an example embodiment.

Throughout the drawing figures, like reference numerals will be understood to refer to like parts and components.

### DETAILED DESCRIPTION

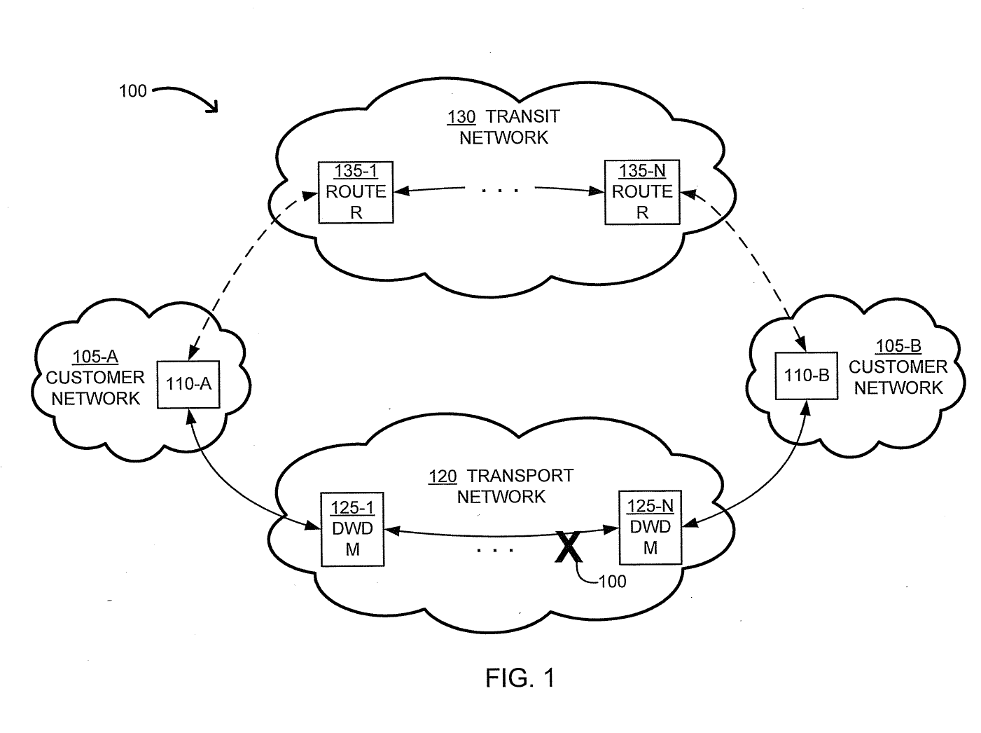

FIG. 1 is a block diagram of a network environment 100 including a customer network 105 (with a first customer location 105-A and second customer location 105-B), a transport network 120, and a transit network 130 (e.g., an Internet Protocol “IP” transit network employing one or more IP routers). A first customer device 115-A in the first customer location communicates with a second customer device 115-B in the second customer location via devices 125-I through 125-N in transport network 120. For example, in one embodiment devices 125-1 through 125-N may include one or more dense wavelength division multiplexing (DWDM) devices or switches. First customer device 115-A may also be in communication with second customer device 115-B via devices 135-1 through 135-N in transit network 130. For example, in one embodiment devices 135-1 through 135-N may include one or more Internet Protocol (IP) routers.

During general operation, customer network 105-A communicates with customer network 105-B via transport network 120. In one embodiment, a network failure 100 may occur in transport network 120. The network failure 100 may be caused by a variety of events such as a link failure (e.g., fiber cut), node failure (e.g., DWDM device malfunction), or any other number of scenarios that could cause a disruption or cessation of service across transport network 120. The network failure 100 can be detected internally and/or externally to the transport network 120 by one or more devices, software applications and/or other means for detecting network failures/disruptions. According to one embodiment, in response to detecting the network failure 100 (e.g., link failure, node failure, etc.), transit network 130 is provisioned to carry traffic for customer 105 that would otherwise be carried over transport network 120 but for the network failure 100 in transport network 120. In this manner, transit network 130 can be used as a failover network for transport network 120. In one embodiment, the switch-over from transport network 120 to transit network 130 is transparent (or at least substantially transparent) to customer network 105 (or any users thereof). Additionally, once the network failure 100 (or any other network deficiency and/or anomaly) is remedied and transport network 120 is once again operational, service for customer 105 reverts back to transport network 120 from transit network 130.

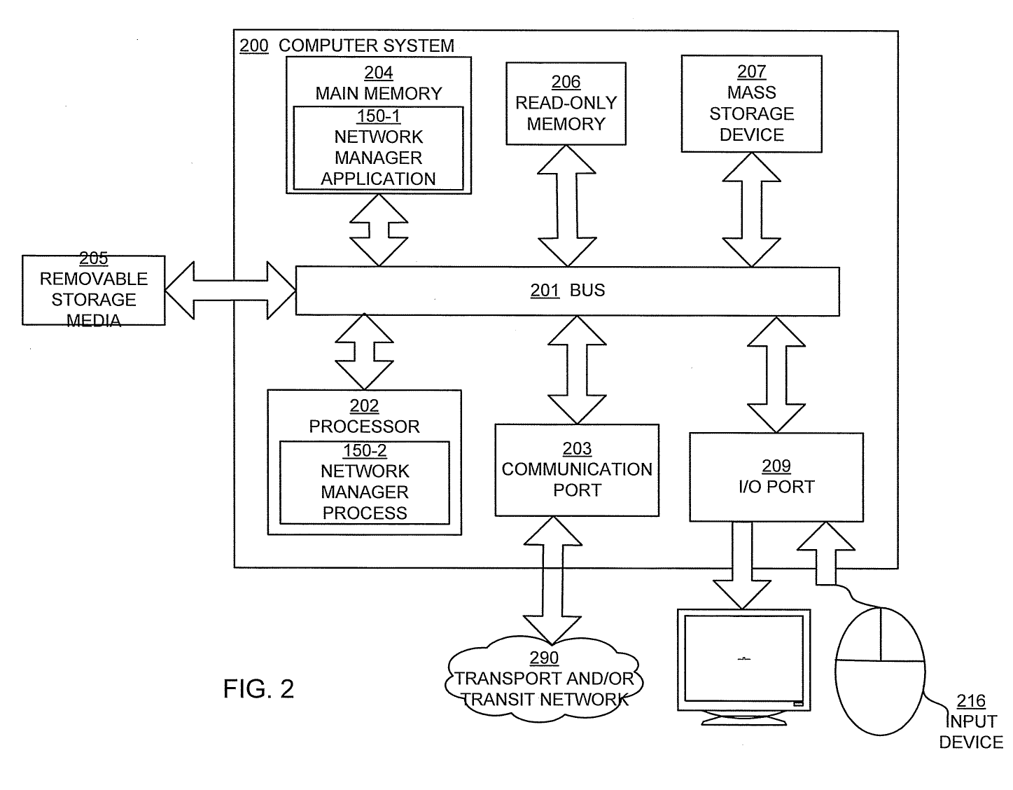

FIG. 2 is a schematic diagram of a computer system 200 upon which embodiments of the present invention may be carried out and implemented. For example, one or more computing devices 200 (e.g., servers, switches, routers, gateways, etc.) may be used to manage and perform network failover detection and routing.

According to the present example, the computer system 200 includes a bus 201 (i.e., interconnect), at least one processor 202, at least one communications port 203, a main memory 204, a removable storage media 205, a read-only memory 206, and a mass storage 207. Processor(s) 202 can be any known processor, such as, but not limited to, an Intel® Itanium® or Itanium 2® processor(s), AMD® Opteron® or Athlon MP® processor(s), or Motorola® lines of processors. Communications ports 203 can be any of an RS-232 port for use with a modem based dial-up connection, a 10/100 Ethernet port, a Gigabit port using copper or fiber, or a USB port. Communications port(s) 203 may be chosen depending on a network such as a Local Area Network (LAN), a Wide Area Network (WAN), or any network to which the computer system 200 connects (e.g., transport and/or transit network 290). The computer system 200 may be in communication with peripheral devices (e.g., display screen 230, input device 216) via Input/Output (I/O) port 209.

Main memory 204 can be Random Access Memory (RAM), or any other dynamic storage device(s) commonly known in the art. Read-only memory 206 can be any static storage device(s) such as Programmable Read-Only Memory (PROM) chips for storing static information such as instructions for processor 202. Mass storage 207 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 201 communicatively couples processor(s) 202 with the other memory, storage and communications blocks. Bus 201 can be a PCI/PCI-X, SCSI, or Universal Serial Bus (USB) based system bus (or other) depending on the storage devices used. Removable storage media 205 can be any kind of external hard-drives, floppy drives, IOMEGA® Zip Drives, Compact Disc—Read Only Memory (CD-ROM), Compact Disc—Re-Writable (CD-RW), Digital Video Disk—Read Only Memory (DVD-ROM), etc.

Embodiments herein may be provided as a computer program product, which may include a machine-readable medium having stored thereon instructions, which may be used to program a computer (or other electronic devices) to perform a process. The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

As shown, main memory 204 is encoded with network manager application 150-1 that supports functionality as discussed above and as discussed further below. Network manager application 150-1 (and/or other resources as described herein) can be embodied as software code such as data and/or logic instructions (e.g., code stored in the memory or on another computer readable medium such as a disk) that supports processing functionality according to different embodiments described herein. During operation of one embodiment, processor(s) 202 accesses main memory 204 via the use of bus 201 in order to launch, run, execute, interpret or otherwise perform the logic instructions of the network manager application 150-1. Execution of network manager application 150-1 produces processing functionality in network manager process 150-2. In other words, the network manager process 150-2 represents one or more portions of the network manager application 150-1 performing within or upon the processor(s) 202 in the computer system 200.

It should be noted that, in addition to the network manager process 150-2 that carries out method operations as discussed herein, other embodiments herein include the network manager application 150-1 itself (i.e., the un-executed or non-performing logic instructions and/or data). The network manager application 150-1 may be stored on a computer readable medium (e.g., a repository) such as a floppy disk, hard disk or in an optical medium. According to other embodiments, the network manager application 150-1 can also be stored in a memory type system such as in firmware, read only memory (ROM), or, as in this example, as executable code within the main memory 204 (e.g., within Random Access Memory or RAM). For example, network manager application 150-1 may also be stored in removable storage media 205, read-only memory 206, and/or mass storage device 207.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware.

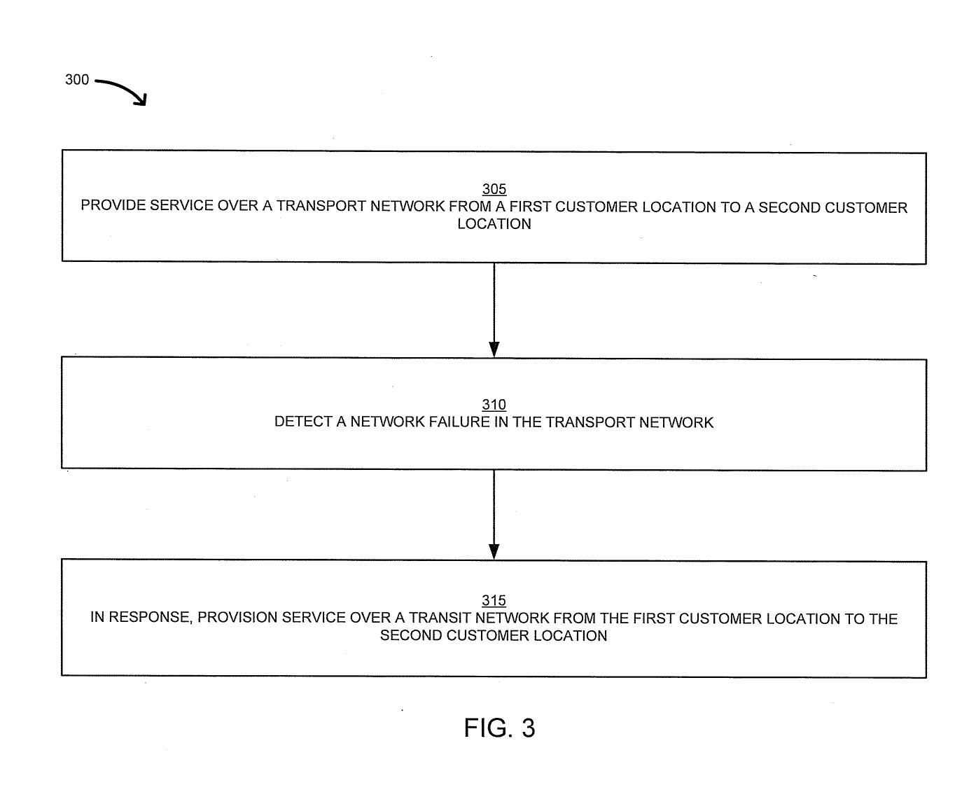

FIG. 3 includes a flowchart according to embodiments herein. The rectangular elements are herein denoted as “steps” and represent computer software instructions or groups of instructions that carry out such functions. The flow diagrams do not necessarily depict the syntax of any particular programming language. Rather, the flow diagrams illustrate the functional information one of ordinary skill in the art could use to fabricate circuits or to generate computer software (or a hybrid of both circuits and software code) to carry out the features as described herein.

It should be noted that many routine program elements, such as initialization of loops and variables and the use of temporary variables are inherent in the flowcharts. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Now, more specifically, FIG. 3 is a flow chart 300 of processing steps that shows processing operations performed by the network manager 150 (i.e., network manager application 150-1 and/or the run-time implementation of network manager process 150-2) in accordance with one example embodiment.

In step 305, the network manager 150 provides service over a transport network (e.g., employing one or more DWDM devices, switches, etc.) from a first customer location to a second customer location.

In step 310, the network manager 150 detects a network failure in the transport network (e.g., link failure, node failure, etc.).

In step 315, in response to detecting the network failure, the network manager 150 provisions service over a transit network (e.g., IP transit network employing one or more IP routers, switches, etc.) from the first customer location to the second customer location.

Although the present invention has been described with reference to various embodiments, it will be understood that the invention is not limited to the details thereof. Various modifications and substitutions will occur to those of ordinary skill in the art. All such substitutions are intended to be embraced within the scope of the invention as defined in the appended claims.

What is claimed is:

1. A method comprising:
providing service over a transport network from a first customer location to a second customer location;
detecting a network failure in the transport network; and
in response, provisioning service over an Internet Protocol (IP) transit network from the first customer location to the second customer location.

2. The method as recited in claim 1, wherein the network failure is caused by a link failure in the transport network.

3. The method as recited in claim 1, wherein the network failure is caused by a node failure in the transport network.

4. The method as recited in claim 3, wherein the node causing the network failure is a dense wavelength division multiplexing (DWDM) device.
